(19) United States
(12) Patent Application Publication
(10) Pub. No.: US 2022/0261733 A1
(43) Pub. Date: Aug. 18, 2022

(54) iTAAP: Improving Academic Achievement Through Predictive Analysis

(71) Applicant: Arjun Singh Kushwaha, Pasadena, CA (US)

(72) Inventor: Arjun Singh Kushwaha, Pasadena, CA (US)

(21) Appl. No.: 17/163,856

(22) Filed: Feb. 1, 2021

(51) Int. Cl. G06Q 10/06; G06Q 50/20

(52) U.S. Cl. CPC G06Q 10/06393; G06Q 50/20

(57) ABSTRACT

Aspects of the disclosure are directed to improving academic achievement through predictive analysis. In accordance with one aspect, a method for determining a performance level of college readiness including inputting a number of current students who performed a prepared status; dividing the number of current students by a total number of current students to generate a current year data; subtracting a prior year data from the current year data to generate a difference; sorting the difference in a first category; sorting the current year data in a second category; and determining the performance level based on the first category and the second category.

### TECHNICAL FIELD

This disclosure relates generally to the field of improving academic achievement through predictive analysis.

### BACKGROUND

Determining performance level is desirable.

### SUMMARY

In one aspect, the disclosure provides improving academic achievement through predictive analysis.

### BRIEF DESCRIPTION OF THE DRAWINGS

FIG. 1 illustrates an example five-by-five grid for Chronic Absenteeism.

FIG. 2 illustrates an example five-by-five grid for Elementary School Suspension Rate.

FIG. 3 illustrates an example of each of four performance levels of the English Language Proficiency Assessments for California (ELPAC).

FIG. 4 illustrates an example five-by-five grid for the Graduation Rate.

FIG. 5 illustrates an example five-by-five grid for the English Language Arts/Literacy (ELA) Academic Measure.

FIG. 6 illustrates an example five-by-five grid for College/Career.

FIG. 7 illustrates an example of school future performance scores.

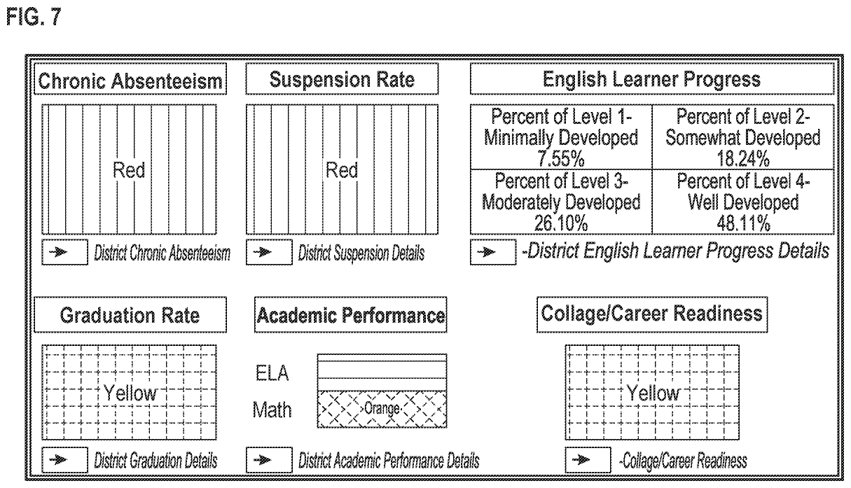

FIG. 8 illustrates an example 2018-2019 graduation cohort proportionality count.

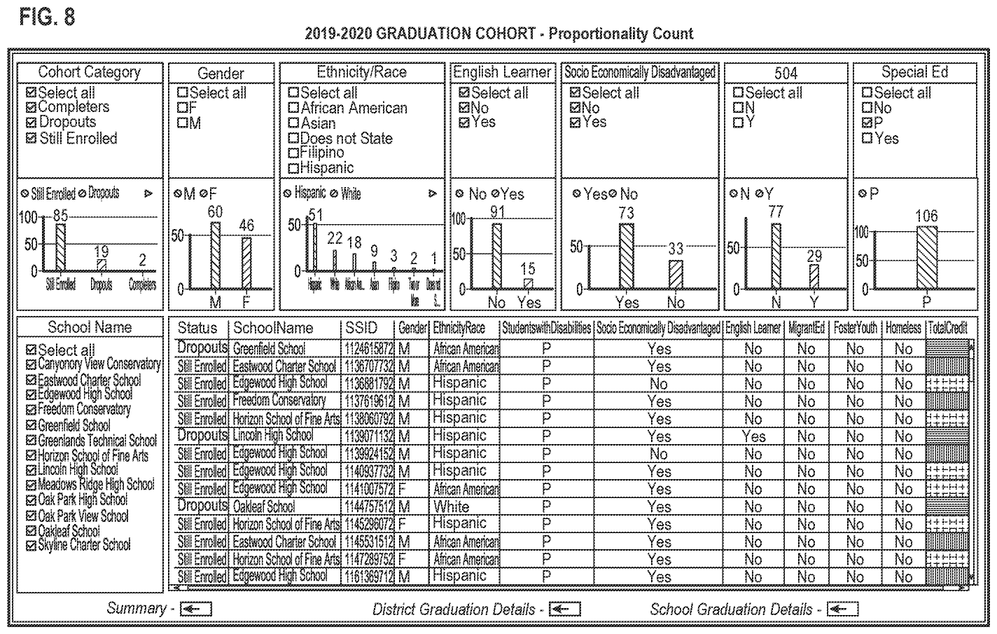

FIG. 9 illustrates an example graph of English learner progress.

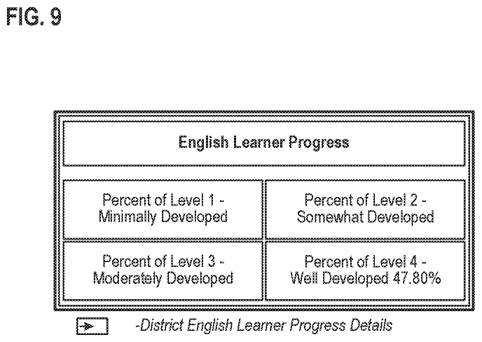

FIG. 10 illustrates an example of discipline incidents.

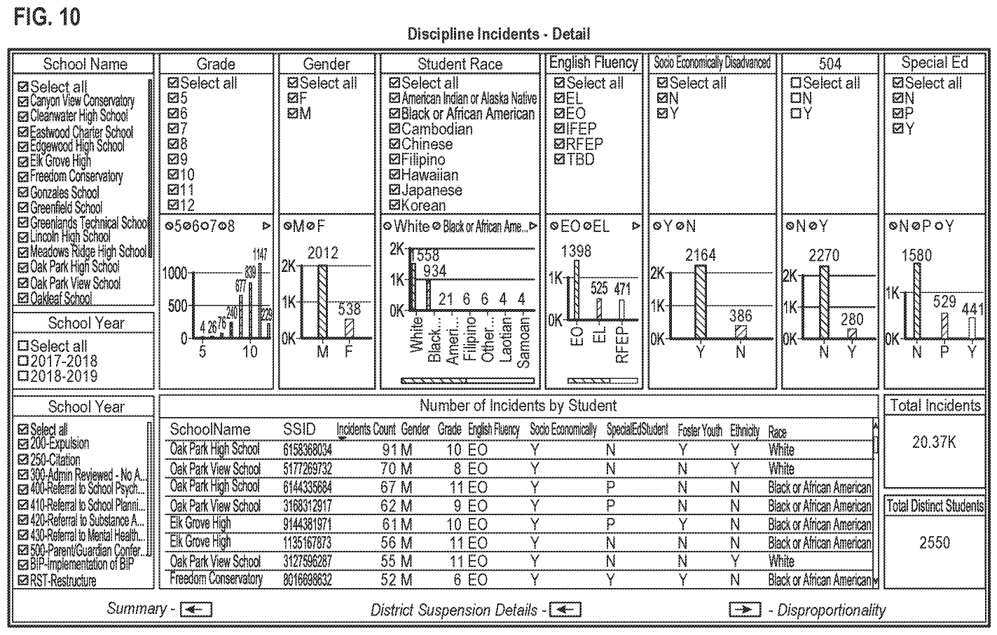

### DETAILED DESCRIPTION

iTAAP Dashboard Calculation Measures: Chronic Absenteeism. This measure is based on the number of students who were chronically absent. Students are considered chronically absent if they are absent at least 10 percent of the instructional days that they were enrolled to attend in a school. A distinguishing feature of this measure is that the goal is reversed. For most of the other measures, the desired outcome is a high number or percent in the current year and an increase from the prior year. For this measure, however, the desired outcome is a low suspension rate, which means a low percent in the current year and a decline from the prior year rate.

Calculations. In the 2018 Dashboard, performance on this measure is determined by (1) the percent of students in a school or district or student group who were absent for 10 percent or more of instructional days they were enrolled to attend, and (2) whether results (i.e., the chronic absenteeism rate) increased or declined between the prior year and the current one.

Current Year Chronic Absenteeism Formula. Number of students absent for at least 10 percent of instructional days divided by cumulative enrollment.

Difference from the Prior Year Chronic Absenteeism Formula. Current year chronic absenteeism rate minus prior year chronic absenteeism rate.

Determining a Performance Level. Based on the current year and prior year data, a performance level (or color) will be given for this measure. The performance level is determined by using a five-by-five colored grid. Example: Temple Middle School has the following chronic absenteeism data:
In the current year, its chronic absenteeism rate was 7.0 percent (i.e., 7 percent of its students were absent at least 10 percent of the instructional days).
From the prior year to the current one, the chronic absenteeism rate increased by 3 percent.

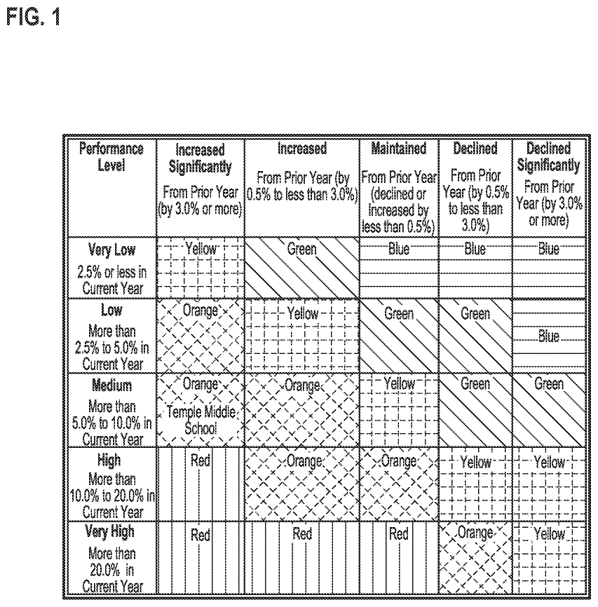

Using the five-by-five grid for Chronic Absenteeism (FIG. 1), we see that a chronic absenteeism rate of 7 percent is considered “Medium” (see left column). At the same time, an increase of 3 percentage points from the prior year is significant (see top row). On the grid, “Medium” and “Increased Significantly” intersect at the orange performance level.

Suspension Rate Calculation. Suspension data vary by local education agency (LEA) and school type. For example, rates at the middle school level are generally higher than at the elementary school level. Therefore, different sets of cut scores are used to determine performance for this measure. LEAs and schools receive the appropriate cut scores and five-by-five colored table based on their school type (elementary, middle, and high) or LEA type (elementary, high, and unified). Another distinguishing feature of this measure is that the goal is reversed. For most of the other measures, the desired outcome is a high number or percent in the current year and an increase from the prior year. For this measure, however, the desired outcome is a low suspension rate, which means a low percent in the current year and a decline from the prior year rate.

Calculations. Performance on this measure is determined by (1) the percent of students in a school or district or student group who were suspended anytime during the school year, and (2) whether results (i.e., the suspension rate) increased or declined from the prior year.

Suspension Rate Formula. Number of students suspended in current year divided by cumulative enrollment.

Difference from Prior Year Suspension Rate Formula. Current year suspension rate minus prior year suspension rate.

Determining a Performance Level. Based on the current year and prior year data, a performance level (or color) will be given for this measure. The performance level is determined by using a five-by-five colored grid. Example: Little League Elementary School has the following suspension rate data:
In the current year, its suspension rate was 4.0 percent.
From the prior year to the current one, the suspension rate declined by 1.6 percentage points.

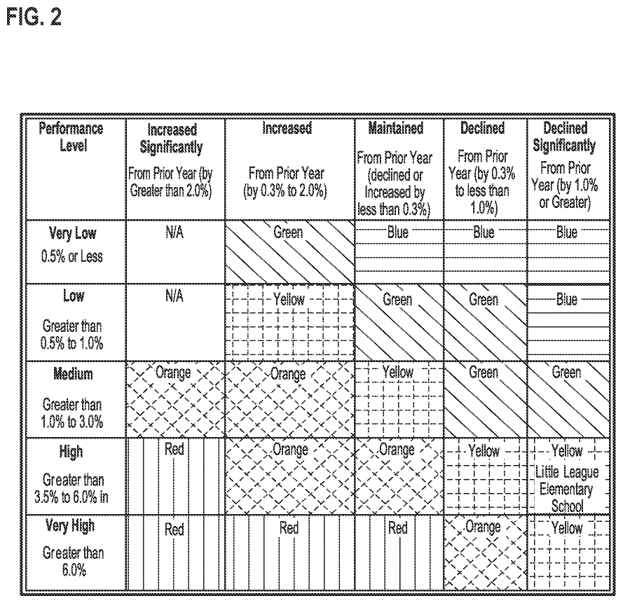

Using the five-by-five grid for Elementary School Suspension Rate (FIG. 2), we see that suspension rate of 4.0 percent is considered “High” (see left column). At the same time, a decline of 1.6 percentage points from the prior year is significant (see top row). On the grid, “High” and “Declined Significantly” intersect at the yellow performance level.

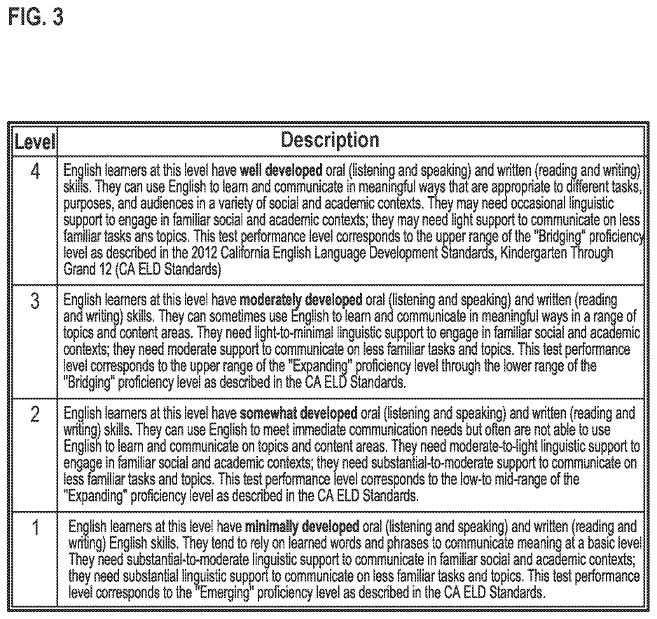

English Learner Progress Calculation. California has transitioned to a new English proficiency assessment: the English Language Proficiency Assessments for California (ELPAC). Because the ELPAC is a new test, a performance level (color) is not available. Therefore, the Dashboard will report the percent of English learner students who scored in each of ELPAC's four performance levels (FIG. 3):
Level 1—Minimally Developed
Level 2—Somewhat Developed
Level 3—Moderately Developed
Level 4—Well Developed

Graduation Rate Calculation. For traditional high schools the graduation rate is based on the number of students who graduate with a regular high school diploma within four years. For schools participating in the Dashboard Alternative School Status (DASS) program a modified method will be used to calculate the graduation rate in order to fairly evaluate the success and progress of DASS schools, which serve high-risk students. This modified method is based on students who are in grade twelve and is referred to as the DASS Graduation Rate.

Defining a Graduation Cohort. For traditional schools, a graduation cohort is a group of high school students who could potentially graduate with a regular high school diploma within four years of entering grade nine. For DASS schools, a graduation cohort is a group of students who:
attend a DASS school,
have been assigned to grade twelve, and
received (1) a regular high school diploma or (2) an alternative certification approved for DASS schools.

Calculations. In the 2018 Dashboard, performance on this measure is determined by (1) the percent of students in the Class of 2018 who graduated, and (2) whether results (i.e., the graduation rate) improved or declined between 2017 and 2018.

Current Year Graduation Rate Formula. Number of students who graduated divided by total number of students in the prior year graduating cohort.

Difference from Prior Year Graduation Rate Formula. Current year graduation rate minus prior year graduation rate. For details on who should be counted in the numerator and denominator, please see the California School Dashboard Technical Guide: 2018-19 School Year.

Determining a Performance Level. Based on the current year and prior year data, a performance level (or color) will be given for this measure. The performance level is determined by using a five-by-five colored grid. Example: Big League High School has the following graduation rate data:
In the current year, its graduation rate was 96.0 percent.
From the prior year to the current one, the graduation rate declined by 0.9 percentage points.

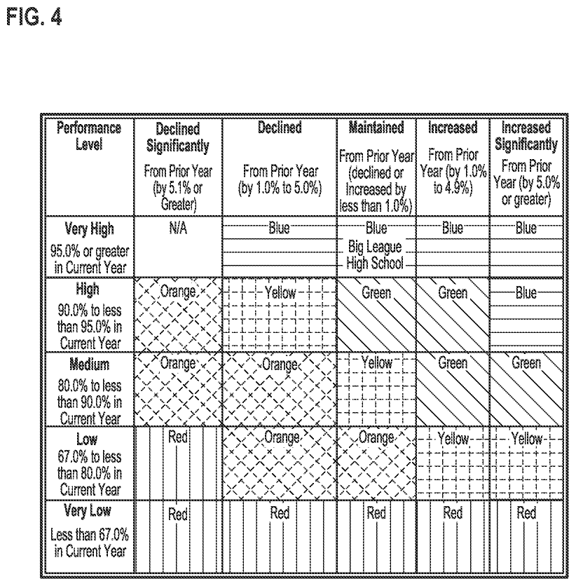

Using the five-by-five grid for the Graduation Rate (FIG. 4), we see that a graduation rate of 96 percent is considered “Very High” (see left column). Additionally, a decline of 0.9 percentage points from the prior year falls into the “Maintained” level (i.e., declined or increased by less than 1.0 percent) on the grid, “Very High” and “Maintained” intersect at the blue performance level, which is the highest level possible.

Academic Performance Calculation. This measure is based on performance on the Smarter Balanced Summative Assessments for English Language Arts/Literacy (ELA) and mathematics-which is administered to students in grades three through eight and grade eleven—and how far the average student is from meeting the grade-level standard, or the “Distance from Standard” (DFS).

To calculate the DFS, each student's score is first compared to the “Standard Met” threshold for that grade level on the Smarter Balanced Summative Assessments. Then, all distance results are averaged to produce a school- and student-group-level average scale score (the DFS). The results will show the needed improvement to bring the average student score to “Standard Met” or the extent to which the average student score meets or exceeds “Standard Met”.

Using scale scores, rather than reporting on the percent of students who performed at or above the “Standard Met”, provides a more comprehensive picture of how all students at the school are performing on the Smarter Balanced assessments. More information regarding the DFS methodology is provided in the California School Dashboard Technical Guide (PDF).

Calculations. In the 2018 Dashboard, performance on this measure is determined by (1) the DFS for ELA or mathematics, and (2) whether results improved or declined between 2017 and 2018. Please note that there are two separate five-by-five colored tables for grades three through eight and grade eleven. However, schools that serve students in Kindergarten through grade twelve, as well as unified school districts, will receive a performance level (color) based on the five-by-five colored table adopted for grades three through eight.

Current Year DFS Formula* for Grades Three through Eight and Eleven. Sum of all DFS scores on the Smarter Balanced Summative Assessments divided by total number of Smarter Balanced Summative Assessments test takers. For the complete business rules, please view the California School Dashboard Technical Guide (PDF). *Specific inclusion and exclusion rules, such as continuous enrollment, are applied to determine the numerator and denominator.

Difference from Prior Year DFS. Current Year DFS minus Prior Year DFS.

Determining a Performance Level. Based on the current and prior year DFS, a performance level (or color) will be given for this measure. The performance level is determined by using a five-by-five colored grid. Example: Little League Elementary School has the following ELA academic data:
In the current year, its DFS was +12.7 (i.e., 12.7 points above “Standard Met”).
From the prior year to the current one, the DFS increased by 4 points.

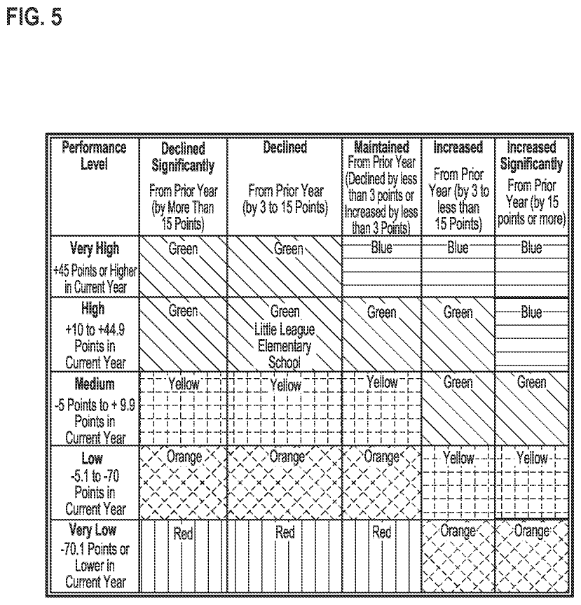

Using the five-by-five grid for the ELA Academic Measure (FIG. 5), we see that a DFS of +12.7 is considered “High” (see left column). Additionally, an increase of 4 points from the prior year falls into the “Increased” level (see top row). On the grid, “High” and “Increased” intersect at the Green performance level, which is the second highest level.

College/Career Readiness Calculation. This measure is based on the number of students in a high school graduation cohort who are prepared for college or a career. College or career readiness means completing rigorous coursework, passing challenging exams, or receiving a state seal. The following measures are approved as indicating college or career readiness:
Career Technical Education Pathway Completion
Grade 11 Smarter Balanced Summative Assessments in ELA and mathematics
Advanced Placement Exams
International Baccalaureate Exams
College Credit Course (formerly called Dual Enrollment)
a-g Completion
State Seal of Biliteracy (New)
Military Science/Leadership (New)

Calculations. In the 2018 Dashboard, performance on this measure is determined by (1) the percent of high school graduates who are “Prepared” (2) whether results (i.e., preparedness) improved or declined between the prior year and the current one.

Current Year College/Career Formula. Number of graduates in the current year class who performed “Prepared” divided by total number of students in the current year class.

Difference from 2017 College/Career. Current year data minus prior year data.

Determining a Performance Level. Based on the current year and prior year data, a performance level (or color) will be given for this measure. The performance level is determined by using a five-by-five colored grid. Example: Big League High School has the following college/career data:
The current year graduating class had 50 students.
Of the 50 students, 30 students were placed in the “Prepared” level.
The prior year's graduating class had 60 students.
Of the 60 students from the prior year class, 30 students were placed in the “Prepared” level.

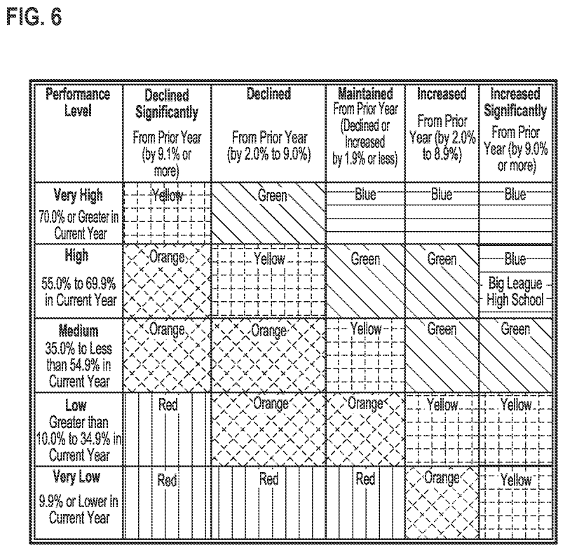

Based on this data, 60 percent of the current year class was “Prepared,” while only 50 percent of the prior year class was “Prepared.” This represents an increase of 10 percentage points between the prior year and the current year. Using the five-by-five grid for College/Career (FIG. 6), we see that a “Prepared” rate of 60 percent is considered “High” (see left column). At the same time, an increase of 10 percentage points from the prior year is significant (see top row). On the grid, “High” and “Increased Significantly” intersect at the blue performance level.

### Frequently Asked Questions-Abstract/Technical Information

1. What information does iTAAP™ include? iTAAP It provides easy-to-use reports that show LEA performance on six state indicators: Chronic Absenteeism, Suspension Rate, English Leamer Progress, Graduation Rate, Academic Performance and College/Career Readiness. There are two main differences between California School Dashboard and the i TAAP™: iTAAP not only shows LEA performance for previous school years, like California School Dashboard does, but also displays the projected color and numbers of the same indicators based on the school's current year performance. It provides LEA opportunities for immediate improvements raise the bar for student learning and increase LCFF funding. iTAAP allows LEA not only to drill down to the school level, like California School Dashboard does, but to identify students which need improvement. For example, analyzing the graduation dashboard of 12 grade students, a school determines that 20 students have low credits and probably would not be able to graduate with the rest of the graduation cohort. The school has opportunity to assist those specific students for credit recovery programs. iTAAP projects what color the school or LEA will have on the graduation indicator if only certain percentage of these low credit students graduate. Similarly, by identifying students, who are projected to be chronic absentee at the end of the school year, gives school personnel an opportunity to work with the families on improving student attendance. As a result, the student attendance improves, as well as California School Dashboard indicator and its color.

2. How accurate is iTAAP™? iTAAP is highly accurate with its predictive analysis. iTAAP incorporates proprietary logic and algorithms to calculate various indicator colors on the lines of CA School Dashboard. It therefore stays ahead of its time to implement any changes to CA School Dashboard in order to keep its forecasting feature accurate. Our current accuracy with CDE dashboard is between 92-97% for predictive analysis.

3. How is different iTAAP™ from California School Dashboard? iTAAP differs from CA School Dashboard in timeliness. While CDE provides color based assessment for an LEA for the past year, iTAAP provides its projections for the future. Since iTAAP is pro-active, each LEA has significant time period to adjust its practices to impact its official CDE Dashboard colors. Further, iTAAP is able to drill down to the student level, without personally identifying a child, and analyze how the student performance indicators changed historically. For example, a student had poor attendance during the last school year and started new school year with number of absences again. This should be an alert to the teachers and school administrators to start working with parents of the child ahead of time and improve the attendance. As a result, the student would earn credits which he/she would lose otherwise. The same applies to the suspension and other performance indicators.

4. How often is iTAAPupdated? As the intention of iTAAP is to improve schools and students performance during the current school year, the data on the dashboard would have to be updated as frequent as it is reasonable. We anticipate updating data weekly. Largely this will depend if LEA will provide Expatiate Communications with sufficient access to CALP ADS and LEA Student Information System.

5. Who will have access to the iTAAP™? Only staff identified by LEA will have access to the iTAAP′.

6. Would different LEAs see each other iTAAP™ data? No, each LEA will be able to see its own data, and would not have any access to the other LEA's dashboards.

7. How is secure data on iTAAP™? The access to the dashboard is password protected. Expatiate Communications maintains strict controls regarding who can access an LEAs data using multiple layers of authentication. In order to protect academic data, iTAAP does not have any identifiable student or staff information. The students only represented by California State Student ID. In order to identify student name, gender or any other personal information, the person would have to have access to CALP ADS or LEA Student Information System.

8. What uses roles are available in iTAAP™ for different levels of access in an LEA? The architecture of iTAAP is flexible enough to be able to configure as many access levels as LEA needs. Based on access level required, iTAAP can be configured for whole LEA, a single school, multiple schools or even for specific classrooms only access.

9. Can data from the iTAAP™ be exported? Both summary and detail data from each dashboard visual component could be exported to Excel or .csv file formats.

10. We already have Student Information System (SIS) which provides dashboard and user report. Why do we need iTAAP™? iTAAP is not meant to be an SIS or a Special Education System. Instead, iTAAP collects data from all school systems and runs its algorithms to provide futuristic predictive analysis for CA School Dashboard Colors.

11. What are the special system and network requirements for implementing iTAAP™ at our LEA? iTAAP is a web based application and does not require installation of any additional programs. There are no special requirements to the LEA network or user's computer.

12. Does iTAAP™ works on mobile devices? Yes, iTAAP can be accessed on mobile devices as well as on desktops and laptops.

13. Which data sources does the iTAAP use and how is the information displayed? iTAAP used data from publicly available data sources like Dataquest, CA School Dashboard, Ed Data and similar other data sets available from State Educational Agencies along with LEA specific data from their own Student information Systems (SIS) to analyze and provide predictive analysis. All results are displayed through an online profile which can be sorted and filtered depending on the use. Data profiles are accessible based on security credentials and are available on a desktop, tablet or mobile devices.

What is claimed is:

1. A method for determining a performance level of college readiness, the method comprising:
inputting a number of current students who performed a prepared status;
dividing the number of current students by a total number of current students to generate a current year data;
subtracting a prior year data from the current year data to generate a difference;
sorting the difference in a first category;
sorting the current year data in a second category; and
determining the performance level based on the first category and the second category.
